(19) United States
(12) Patent Application Publication
(10) Pub. No.: US 2023/0133678 A1
(43) Pub. Date: May 4, 2023

(54) METHOD FOR PROCESSING AUGMENTED REALITY APPLICATIONS, ELECTRONIC DEVICE EMPLOYING METHOD, AND NON-TRANSITORY STORAGE MEDIUM

(71) Applicants: HONG FU JIN PRECISION INDUSTRY (WuHan) CO., LTD., Wuhan (CN); HON HAI PRECISION INDUSTRY CO., LTD., New Taipei (TW)

(72) Inventor: CHI-YU CHANG, New Taipei (TW)

(21) Appl. No.: 17/969,902

(22) Filed: Oct. 20, 2022

(30) Foreign Application Priority Data
Nov. 3, 2021 (CN) 202111296256.8

(51) Int. Cl. G06T 19/00; G06F 16/58; G06F 16/55; G06V 20/60; G06V 10/40; G10L 25/51

(52) U.S. Cl. CPC G06T 19/006; G06F 16/5866; G06F 16/55; G06V 20/60; G06V 10/40; G10L 25/51

(57) ABSTRACT

A method to obtain a more accurate and more immediate augmented reality (AR) user experience in relation to identifying feature-marked or sound-marked objects for sale for example obtains any initial data via a device and determines whether identifiable data is included therein using artificial intelligence (AI) techniques. If so determined, the initial data is stored. The method determining whether such identifiable data is comprised in a predetermined database. If yes, the identifiable data is identified by matching to obtain information. The information in the identifiable data can be stored to the predetermined database to retrain an AI identification model. After AI training of an identification model, data relevant to the commodity taken in written or audio can be outputted into the AR scenario. An electronic device and a non-transitory storage medium are also disclosed.

### TECHNICAL FIELD

The subject matter herein generally relates to augmented reality technology.

### BACKGROUND

Augmented reality technology can be used in client devices, such as smartphones, tablet computers, smart helmets, and smart glasses, etc., to assist in daily life, or identify unknown objects. Current artificial intelligence recognition technology needs to send images of an object to a back-end server, and recognition of the object does not occur in real time. In a store setting where the technology is promoted to potential consumers, it's necessary for the consumers to obtain introduction information, such as the name of the product in the store by scanning a response code of the product. Such settings are not optimal.

### BRIEF DESCRIPTION OF THE DRAWINGS

Implementations of the present technology will now be described, by way of example only, with reference to the attached figures.

FIG. 1 is a flowchart of an embodiment of an augmented reality processing method according to the present disclosure.

FIG. 2 is a flowchart of subdivisions of S5 of FIG. 1 in the method according to FIG. 1.

FIG. 3 is a scene in a first application scene of the method of FIG. 1.

FIG. 4 is a scene in a second application of the method of FIG. 1.

FIG. 5 a diagram of an embodiment of a device for augmented reality processing according to the present disclosure.

### DETAILED DESCRIPTION

In order to understand the application, features and advantages of the application, a detailed description of the application is described through the embodiments and the drawings. It should be noted that, the embodiments of the application and the features in the embodiments can be combined with each other.

Many details are described in the following descriptions, but the embodiments described are only part of the embodiments of the application, not the entirety of embodiments.

Unless defined otherwise, all technical or scientific terms used herein have the same meaning as those normally understood by technicians in the technical field. The following technical terms are used to describe the application, the description is not to be considered as limiting the scope of the embodiments herein.

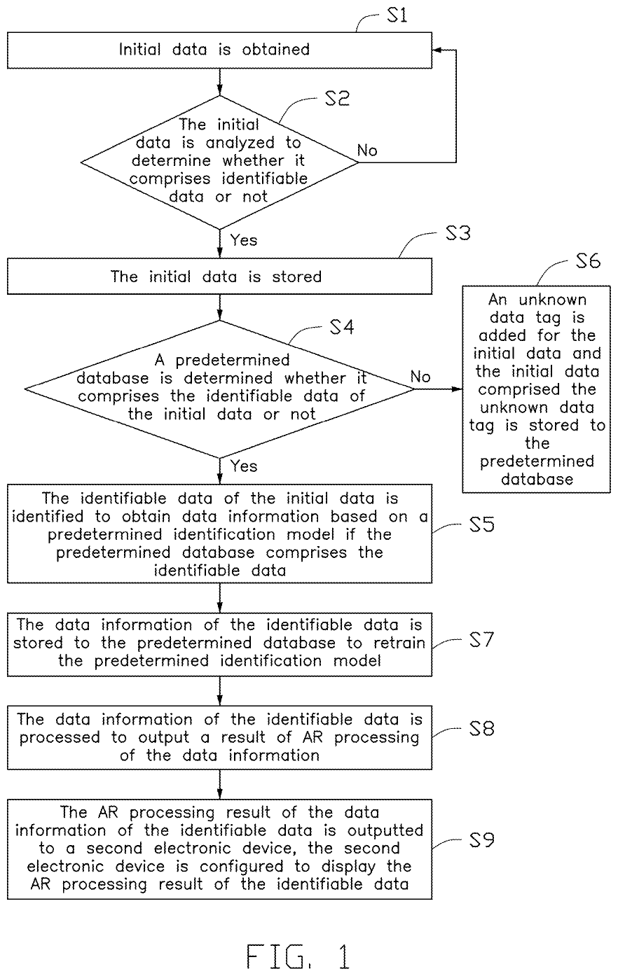

FIG. 1 illustrates one exemplary embodiment of an augmented reality (AR) processing method. The flowchart presents an exemplary embodiment of the method. The exemplary method is provided by way of example, as there are a variety of ways to carry out the method. Each block shown in FIG. 1 may represent one or more processes, methods, or subroutines, carried out in the example method. Furthermore, the illustrated order of blocks is illustrative only and the order of the blocks can change. Additional blocks can be added or fewer blocks may be utilized, without departing from this disclosure. The example method can be operated in a first electronic device and begin at block S1.

In block S1, initial data is obtained.

In one embodiment, the first electronic device can obtain the initial data by multiple ways. For example, when an object is a person or a commodity, an image thereof can be obtained through a camera of the first electronic device (the initial data is the image captured by the camera); when the object is a sound, the sound can be obtained through a microphone or sound pick-up of the first electronic device (the initial data is the sound collected by the microphone or the sound pick-up).

In block S2, the initial data is analyzed to determine whether it comprises identifiable data or not.

In one embodiment, the identifiable data can be any data with characteristics of something or parts of something which can be identified. For example, in the initial data, the shape, color, packaging, appearance, or other characteristics of something (“the object”) that can be identified by a predetermined identification model can be defined as the identifiable data. Theoretically, objects with a three-dimensional structure have more identifiable features and enable a higher degree of recognition. Flat objects such as paintings, need to have unique colors or patterns.

In block S3, the initial data is stored if the initial data comprises the identifiable data.

In one embodiment, if the initial data comprises the identifiable data, the initial data can be stored to a specified storage area for future archiving or analysis.

In one embodiment, if the initial data does not comprise the identifiable data, the initial data can be abandoned.

In one embodiment, if the initial data comprises the identifiable data, the identifiable data can be extracted from the initial data and stored into the specified storage area. The initial data can also be stored into the specified storage area. For example, the identifiable data and the initial data can be configured to retrain a predetermined identification model. The predetermined identification model can comprise algorithms as to descriptions of different characteristics corresponding to different objects.

In one embodiment, if the initial data does not comprise the identifiable data, this may indicate that no element of characterization can be identified by the predetermined identification model, and such initial data can be defined as invalid data. The subsequent processing of the initial data can be omitted, and the method can jump to execute block S1.

In block S4, a predetermined database is determined whether it comprises the identifiable data of the initial data or not.

In one embodiment, the predetermined database can comprise multiple identification data. The identification data can be data as to characteristics of objects identified in the past or pre-stored in the predetermined database.

If the identifiable data of the initial data is found to be comprised in the predetermined database, selection of a matched feature algorithm can be done. For example, when the predetermined database is determined to comprise the identifiable data of the initial data, a previously used algorithm is selected to identify the identifiable data of the initial data.

In block S5, the identifiable data of the initial data is identified to obtain data information based on a predetermined identification model if the predetermined database comprises the identifiable data.

In one embodiment, when the predetermined database comprises the identifiable data, the predetermined identification model can be used to identify the identifiable data. For example, firstly, the identifiable data is identified to determine whether the identifiable data relates to a person or an object, or whether the identifiable data only comprises environmental characteristics (that is, does not comprise person characteristics or object characteristics), to achieve a distinction; secondly, the artificial intelligence algorithm of the predetermined identification model is configured to identify the distinguished identifiable data to reduce a possibility of error; a probability of coincidence or repetition within the identifiable data can be calculated by the artificial intelligence algorithm, and information as to the identifiable data can be generated based on the calculation.

In one embodiment, the steps of training the predetermined identification model can comprise: obtaining original training data and processing the original training data to obtain feature data that is configured to describe the original training data; using artificial intelligence algorithms to classify the feature data which belongs to the same object, training classified feature data to obtain a predetermined identification model; identifying the identifiable data according to the predetermined identification model, and classifying and storing the result of identification, it can be used for the artificial intelligence algorithms to add new classification identification.

In block S6, an unknown data tag is added for the initial data and the initial data comprised the unknown data tag is stored to the predetermined database if the predetermined database does not comprise the identifiable data.

In one embodiment, if the predetermined database does not comprise the identifiable data, the initial data of the unknown object is added the unknown data tag, and the initial data comprising the unknown data tag is stored to the predetermined database to retrain the predetermined identification model.

In block S7, the data information of the identifiable data is stored to the predetermined database to retrain the predetermined identification model.

In one embodiment, the data stored in the predetermined database of block S6 and block S7 can be classified, and the classified data can be combined. For example, unknown data and identified data can be reclassified, the classified data can be combined, and the unknown data that cannot be identified or classified is separated into an unknown object to retrain the predetermined identification model, it can be used for training the predetermined identification model to add new classification identification.

In block S8, the data information of the identifiable data is processed to output a result of AR processing of the data information.

In one embodiment, the data information of the identifiable data is processed to output the AR processing result, the AR processing result can comprise recognizable information of the identifiable data. For example, the recognizable information of the identifiable data can comprise object introduction information, promotion information, etc.

In block S9, the AR processing result of the data information of the identifiable data is outputted to a second electronic device, the second electronic device is configured to display the AR processing result of the identifiable data.

In one embodiment, the second electronic device can comprise a display screen, to display the AR processing result of the data information of the identifiable data.

In one embodiment, the communication connection between the first electronic device and the second electronic device can be a wired network, or a wireless network (for example BLUETOOTH, wireless local area network). Both of the first electronic device and the second electronic device may perform block S1 to obtain the initial data, not limited to the first electronic device. For example, the second electronic device obtains the initial data and share the initial data to the first electronic device. The first electronic devices can be a notebook computer, a tablet, a smart phone etc. The second electronic device can be a smart helmet, a smart glasses, other wearable device, etc.

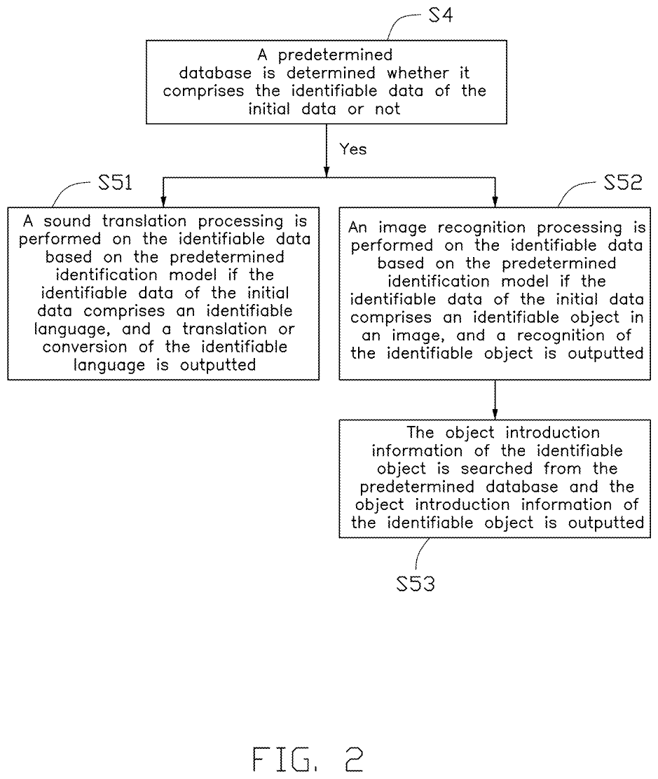

Referring to FIG. 2, block S5 can further comprises block S51, block S52, and block S53.

In block S51, a sound translation processing is performed on the identifiable data based on the predetermined identification model if the identifiable data of the initial data comprises an identifiable language, and a translation or conversion of the identifiable language is outputted.

In block S52, an image recognition processing is performed on the identifiable data based on the predetermined identification model if the identifiable data of the initial data comprises an identifiable object in an image, and a recognition of the identifiable object is outputted.

In block S53, the object introduction information of the identifiable object is searched from the predetermined database and the object introduction information of the identifiable object is outputted.

In one embodiment, In one embodiment, the predetermined database can prestore results of multiple recognitions of identifiable objects and object introduction information corresponding to each of the identifiable objects.

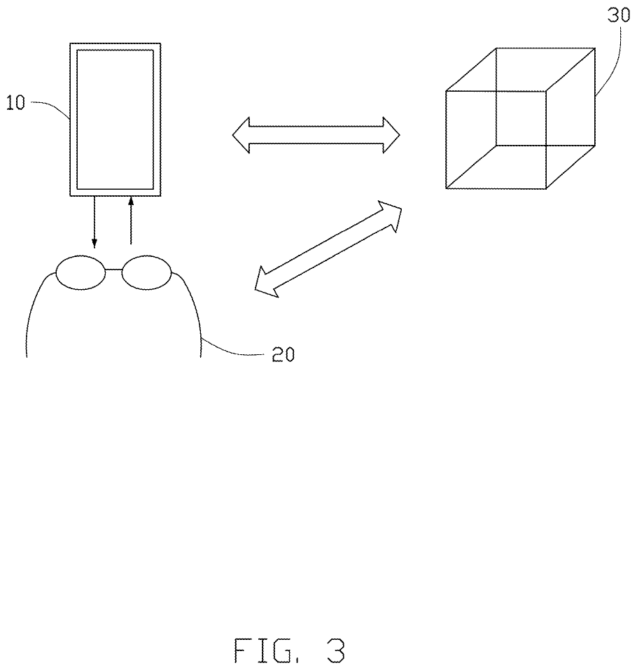

Referring to FIG. 3, a first application of the AR processing method comprises the first electronic device 10, the second electronic device 20, and at least one first object 30. For example, the first electronic device 10 is a smart phone, the smart phone comprises a camera, the second electronic device 20 is AR glasses, the first object 30 is a commodity for sale.

A customer can use the smart phone to capture an image of the commodity. If the AR glasses comprise a camera, the customer can also use the AR glasses to capture the image of the commodity, and the AR glasses can transmit the image of the commodity to the smart phone. The smart phone can be connected to the AR glasses based on a wireless network (for example BLUETOOTH). The shape of the commodity is not limited, for example, the shape of the commodity is three-dimensional shape or two-dimensional shape, shape features of three-dimensional commodity have good recognizability, two-dimensional commodity which comprises uniqueness color and/or pattern also can be recognized.

In one embodiment, the smart phone comprises the predetermined identification model. The smart phone can process and classify the image of the commodity, and the smart phone further determines whether the image of the commodity comprises object features. If the image of the commodity does not comprise object features, the image of the commodity is abandoned, and the smart phone or the AR glasses capture another image of the commodity. If the image of the commodity comprises the object features, the object features of the commodity can be stored in the predetermined database, it can be used for deep learning retraining or classification verification.

The smart phone can determine whether the object features of the commodity is previously identified. In depth recognition domain, different feature algorithms correspond to different object features, if the object features of the commodity are identified in the past, the predetermined identification model with previously used algorithm can be configured to identify the object features of the commodity, which can improve an accuracy of identification of the commodity.

The smart phone can further determine whether the image of the commodity only comprises environmental characteristics for identification (does not comprise commodity characteristics), to achieve a distinction. The predetermined identification model is configured to identify the distinguished object features of the commodity to reduce a possibility of error.

In one embodiment, a probability of coincidence in characteristics of the commodity can be calculated by the predetermined identification model. The identified results of the same commodity can be classified and combined, and images of unknown commodity can be separately archived to a unknown commodity category, and the images of the unknown commodity category can be stored in the predetermined database, it can be used for training the predetermined identification model to add new classification identification.

The identification of the image of the commodity can be outputted to an AR processing system to perform an AR processing to output an AR processing result of the commodity. For example, the AR processing system can be operated in the smart phone or in the AR glasses.

The AR processing result of the commodity displayed on the AR glasses can comprise commodity shape, commodity introduction information, and information related, etc. The AR processing result outputted as display to the AR glasses 20 can achieve an effect of fusing AR display and artificial intelligence object identification. A screen of the AR glasses displays the AR information of the commodity which can achieve a stereoscopic display and show annotations relating to the commodity.

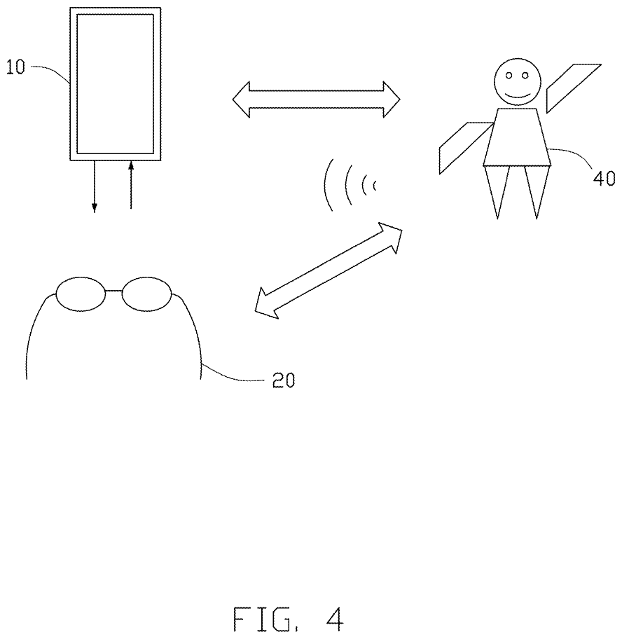

Referring to FIG. 4, a second application of the AR processing method comprises the first electronic device 10, the second electronic device 20, and at least one second object 40 that makes a sound. For example, the first electronic device 10 is a smart phone, the smart phone comprises a microphone or a pickup, the second electronic device 20 is an AR glasses, the second object 40 is a person.

A user (wearing the AR glasses) can use the smart phone to capture a sound spoken for example by the second object 40. If the AR glasses comprises a microphone, the use can also use the AR glasses to capture the sound spoken by the person, the AR glasses can transmit captured sound to the smart phone to identify the captured sound. The smart phone can be connected to the AR glasses by wired network or wireless network. The person may be a clerk, a consumer, or other sources of sound.

For example, the second object 40 may be a product introducer of a shop or a shopping mall, such as a loudspeaker. That is, the second object 40 may be a person or an electronic device.

In one embodiment, the smart phone comprises the predetermined identification model. The smart phone can process and classify the captured sound, the captured sound can be key feature voiceprint data to determine whether the captured sound comprises human sound or only comprises environmental sound for identification (does not comprise human sound feature), to achieve a distinction. The predetermined identification model is configured to identify the distinguished sound to reduce a possibility of error. If the captured sound does not comprise human sound feature, the captured sound can be abandoned, and the smart phone or the AR glasses capture another or further sound. If the captured sound comprises human sound feature, the smart phone can further determine whether the captured sound belongs to specified language (which can be translated by a translation system). The captured sound comprising human sound feature can be stored in the predetermined database, it can be used for deep learning retraining or classification verification. The translation system can be operated in the smart phone or the AR glasses.

In one embodiment, the smart phone can determine whether the captured sound is previously identified. In depth recognition domain, different feature algorithms corresponding to different sound features, if the sound feature of the captured sound is identified in the past, the predetermined identification model with previously used algorithm can be configured to identify the captured sound, which can improve an accuracy of identification of the captured sound.

In one embodiment, a probability of coincidence or repetition of characteristics revealed by the captured sound can be calculated by the predetermined identification model. The identified results of the same language can be classified and combined, and sound of unknown language can be separately archived to a unknown sound category, and the unknown sound category can be stored in the predetermined database, it can be used for training the predetermined identification model to add new classification identification.

The identified result of the captured sound can be outputted to the translation system as input thereto. The translation result of the captured sound can be corrected for pace and content, and the corrected translation result can be outputted to the AR glasses to play audibly.

The translation result of the captured sound can also be classified to store in the predetermined database for analysis or model training.

A loudspeaker of the AR glasses can audibly play the corrected translation result in real time to achieve an effect of fusing language translation and artificial intelligence identification.

In one embodiment, the scenarios of the first application and the second application can be integrated together, that is, the AR display and language translation can be achieved simultaneously. For example, when a user enters a mall, the smart phone or the AR glasses can capture image data and sound data. If the sound data is not the environmental sound, the smart phone can search for the sound data of the current object from a past sound database (for example, the predetermined database), and if a sound-related storage information is searched for and found in the past sound database, an AR display and an audio output can be achieved with respect to the current object. If a sound-related storage information is not searched in the past sound database, an AR display can be achieved with respect to the current object. This kind of application can avoid a bottleneck of object identification difficulties and multi-language translation difficulties, to achieve a better experience in shopping malls.

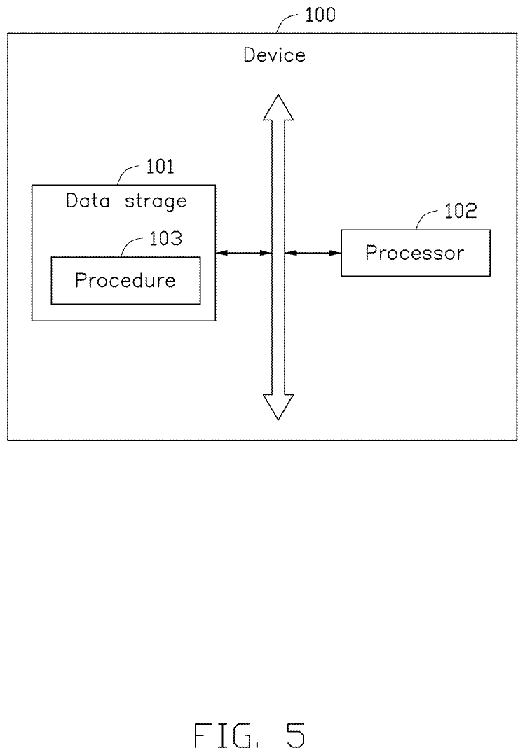

FIG. 5 illustrates one embodiment of a device (device 100) for AR processing. The device 100 can comprise at least one data storage 101, at least one processor 102, and a procedure for AR processing (procedure 103). The procedure 103 may comprise a plurality of computer codes, the computer codes may include commands that can be executed by the processor 102. For example, the processor 102 can execute the computer codes to achieve the AR processing method described in FIG. 1.

In one embodiment, the device 100 can be a computer, a smart phone, or the like. The device 100 can further comprise a camera, a microphone, a network access device, and communication buses.

In one embodiment, the data storage 101 can be in the device 100, or can be a separate external memory card, such as an SM card (Smart Media Card), an SD card (Secure Digital Card), or the like. The data storage 101 can include various types of non-transitory computer-readable storage mediums. For example, the data storage 101 can be an internal storage system, such as a flash memory, a random access memory (RAM) for temporary storage of information, and/or a read-only memory (ROM) for permanent storage of information. The data storage 101 can also be an external storage system, such as a hard disk, a storage card, or a data storage medium. The processor 102 can be a central processing unit (CPU), a microprocessor, or other data processor chip that performs functions of the device 100.

The exemplary embodiments shown and described above are only examples. Many such details are neither shown nor described. Even though numerous characteristics and advantages of the present technology have been set forth in the foregoing description, together with details of the structure and function of the present disclosure, the disclosure is illustrative only, and changes may be made in the detail, including in matters of shape, size, and arrangement of the parts within the principles of the present disclosure, up to and including the full extent established by the broad general meaning of the terms used in the claims. It will therefore be appreciated that the exemplary embodiments described above may be modified within the scope of the claims.

What is claimed is:

1. An augmented reality (AR) processing method comprising:
obtaining initial data and determining whether the initial data comprises identifiable data;
storing the initial data in response to the initial data comprising the identifiable data;
determining whether a predetermined database comprises the identifiable data;
identifying the identifiable data of the initial data to obtain data information of the identifiable data based on a predetermined identification model in response to the predetermined database comprising the identifiable data;
storing the data information of the identifiable data to the predetermined database to retrain the predetermined identification model; and
processing the data information of the identifiable data to output an AR processing result of the identifiable data.

2. The AR processing method of claim 1, wherein storing the initial data comprises:
extracting the identifiable data from the initial data and storing the identifiable data.

3. The AR processing method of claim 1, furthering comprising:
adding an unknown data tag for the initial data and storing the initial data comprised the unknown data tag to the predetermined database in response to the predetermined database does not comprising the identifiable data.

4. The AR processing method of claim 1, further comprising:
classifying stored data of the predetermined database and combining classified data of the predetermined database.

5. The AR processing method of claim 1, further comprising:
outputting the AR processing result of the identifiable data to an electronic device, wherein the electronic device is configured to display the AR processing result of the identifiable data.

6. The AR processing method of claim 1, wherein identifying the identifiable data of the initial data based on a predetermined identification model comprises:
performing a sound translation processing on the identifiable data based on the predetermined identification model in response to the identifiable data of the initial data comprising an identifiable sound.

7. The AR processing method of claim 1, wherein identifying the identifiable data of the initial data based on a predetermined identification model comprises:
performing an image recognition processing on the identifiable data based on the predetermined identification model in response to the identifiable data of the initial data comprising an identifiable object.

8. The AR processing method of claim 7, wherein the predetermined database comprises a recognition result of the identifiable object and an object introduction information of the identifiable object, the AR processing method further comprises:
searching the object introduction information of the identifiable object from the predetermined database and outputting the object introduction information of the identifiable object.

9. An electronic device comprising:
at least one processor; and
a data storage storing one or more programs which when executed by the at least one processor, cause the at least one processor to:
obtain initial data and determine whether the initial data comprises identifiable data;
store the initial data in response to the initial data comprising the identifiable data;
determine whether a predetermined database comprises the identifiable data;
identify the identifiable data of the initial data to obtain data information of the identifiable data based on a predetermined identification model in response to the predetermined database comprising the identifiable data;
store the data information of the identifiable data to the predetermined database to retrain the predetermined identification model; and
process the data information of the identifiable data to output an augmented reality (AR) processing result of the identifiable data.

10. The electronic device of claim 9, wherein the at least one processor storing the initial data comprising:
extracting the identifiable data from the initial data and storing the identifiable data.

11. The electronic device of claim 9, wherein the at least one processor is further configured to:
add an unknown data tag for the initial data and store the initial data comprised the unknown data tag to the predetermined database in response to the predetermined database does not comprising the identifiable data.

12. The electronic device of claim 9, wherein the at least one processor is further configured to:
classify stored data of the predetermined database and combine classified data of the predetermined database.

13. The electronic device of claim 9, wherein the at least one processor is further configured to:
output the AR processing result of the identifiable data to an another electronic device, wherein the another electronic device is configured to display the AR processing result of the identifiable data.

14. The electronic device of claim 9, wherein the at least one processor identifying the identifiable data of the initial data based on a predetermined identification model comprises:
performing a sound translation processing on the identifiable data based on the predetermined identification model in response to the identifiable data of the initial data comprising an identifiable sound.

15. The electronic device of claim 9, wherein the at least one processor identifying the identifiable data of the initial data based on a predetermined identification model comprises:
performing an image recognition processing on the identifiable data based on the predetermined identification model in response to the identifiable data of the initial data comprising an identifiable object.

16. The electronic device of claim 15, wherein the predetermined database comprises a recognition result of the identifiable object and an object introduction information of the identifiable object, the at least one processor is further configured to:
search the object introduction information of the identifiable object from the predetermined database and output the object introduction information of the identifiable object.

17. A non-transitory storage medium having stored thereon instructions that, when executed by a processor of an electronic device, causes the electronic device to perform an augmented reality (AR) processing method, the AR processing method comprising:
obtaining initial data and determining whether the initial data comprises identifiable data;
storing the initial data in response to the initial data comprising the identifiable data;
determining whether a predetermined database comprises the identifiable data;
identifying the identifiable data of the initial data to obtain data information of the identifiable data based on a predetermined identification model in response to the predetermined database comprising the identifiable data;
storing the data information of the identifiable data to the predetermined database to retrain the predetermined identification model; and
processing the data information of the identifiable data to output an AR processing result of the identifiable data.
